(19) United States
(12) Patent Application Publication
(10) Pub. No.: US 2022/0156723 A1
(43) Pub. Date: May 19, 2022

(54) FRACTIONALIZING AND MANAGING OBJECTS USING CRYPTOGRAPHICALLY LINKED BLOCKS

(71) Applicant: Safehaven Labs, Inc., West Jordan, UT (US)

(72) Inventors: Christopher J. Lovato, West Jordan, UT (US); Michael Alan Shattuck, South Jordan, UT (US); Aaron Sterling Bylund, Orem, UT (US)

(21) Appl. No.: 16/953,298

(22) Filed: Nov. 19, 2020

(51) Int. Cl. G06Q 20/36; H04L 9/32; G06Q 40/06

(52) U.S. Cl. CPC G06Q 20/3674; H04L 9/3236; H04L 2209/56; G06Q 40/06; H04L 2209/38; H04L 9/3247

(57) ABSTRACT

Technology for automated investing and divesting of the assets using a blockchain ledger may receive first event data reflecting a divestment event associated with an account of a user. The divestment event includes a transaction value in a base currency. The technology may retrieve, from a database, a diversification setting associated with the user; determine, based on the diversification setting and the transaction value, a first amount of an asset to divest; access, via a network, a blockchain ledger to verify, using a unique identifier associated with the user and an asset identifier identifying the asset, that the first amount of the asset to divest is available; process a first exchange of the first amount of the asset for a first corresponding amount of the base currency; and record, in the blockchain ledger using the unique identifier associated with the user, that the first amount of the asset was divested.

### BACKGROUND

The specification generally relates to token-based object management, and in a more particular non-limiting example, fractionalizing and managing objects using cryptographically linked blocks.

Many users, especially those of the generation referred to colloquially as millennials, have a distrust of traditional financial institutions due to a perceived history of bad behavior, such the assessment of high transaction and brokerage fees and penalties. Further, the process of opening multiple accounts at different institutions, one at a brokerage firm, another with a cryptocurrency exchange, and another with a traditional bank and then managing funds between the accounts can be difficult and time-consuming. These users still have a desire to invest their money, they are just seeking better options for growing their assets without having to spend a lot of time managing them.

A new class of autonomous, programmatic financial “FinTech” services, sometimes referred to as “robo-advisors,” has emerged in the last few years. Such services leverage artificial intelligence to offer analogous services to that offered both by traditional brokerage houses, but at a lower cost. However, while the technology provided by these robo-advisors may be adequate for long term stock-based investments based on pre-allocated funds, they are deficient when it comes to accounting for daily spending needs of users. Further, the robo-advisors that offer debit card technology that is capable of determining when and how to liquidate stocks, so users are only able to access their actual fiat currency-based account balance. Moreover, these existing services generally do not offer access to other asset types, such as precious metals, foreign currencies, and cryptocurrencies even though there is a demand given the technical incompatibilities between the systems that manage these assets. Thus, an integrated user experience is not currently available, particularly one that provides for robust, machine-determined automated divesting so that a user can utilize assets other than his/her bank account balance for cover day-to-day spending needs.

### SUMMARY

According to one innovative aspect of the subject matter described in this disclosure, a computer-implemented method comprises: receiving first event data reflecting a divestment event associated with an account of a user, the divestment event including a transaction value in a base currency; retrieving, from a database, a diversification setting associated with the user; determining, based on the diversification setting and the transaction value, a first amount of an asset to divest; accessing, via a network, a blockchain ledger to verify, using a unique identifier associated with the user and an asset identifier identifying the asset, that the first amount of the asset to divest is available; processing a first exchange of the first amount of the asset for a first corresponding amount of the base currency; and recording, in the blockchain ledger using the unique identifier associated with the user, that the first amount of the asset was divested.

In general, another innovative aspect of the subject matter described in this disclosure may be embodied in systems comprising: one or more processors; a memory storing instructions, which when executed cause the one or more processors to: receive first event data reflecting a divestment event associated with an account of a user, the divestment event including a transaction value in a base currency; retrieve, from a database, a diversification setting associated with the user; determine, based on the diversification setting and the transaction value, a first amount of an asset to divest; access, via a network, a blockchain ledger to verify, using a unique identifier associated with the user and an asset identifier identifying the asset, that the first amount of the asset to divest is available; process a first exchange of the first amount of the asset for a first corresponding amount of the base currency; and record, in the blockchain ledger using the unique identifier associated with the user, that the first amount of the asset was divested.

Other embodiments of one or more of these aspects include corresponding methods, systems, apparatuses, and computer program products, configured to perform the actions of the methods, encoded on computer storage devices.

These and other embodiments may each optionally include one or more of the following operations. For instance, another aspect of the subject matter of this disclosure may be embodied in methods that include determining that the first amount of the asset includes at least a fractional share; determining a number of cryptographically signed asset tokens to reallocate based on the first amount of the asset; recording, in the blockchain ledger, a reallocation of the number of cryptographically signed asset tokens representing the first amount of the asset to a token pool; determining that the first amount of the asset includes at least a fractional share, wherein at least a portion of the number of cryptographically signed asset tokens represents the fractional share; receiving second event data reflecting an investment event associated with the account of the user, the investment event including a deposit value in the base currency; retrieving, from the database, the diversification setting associated with the user; determining, based on the diversification setting, an investment amount of the deposit value to invest in the asset; requesting, via the network, a transfer of the investment amount of the deposit value to invest in the asset from a fiat currency account associated with the user at a digital banking system; processing a second exchange of the investment amount of the deposit value for a second amount of the asset; recording, in the blockchain ledger using the unique identifier associated with the user, that the second amount of the asset was acquired; and transferring, via the network to a fiat currency account associated with the user at a digital banking system, at least the first corresponding amount of the base currency.

These and other embodiments may each optionally include one or more of the following features. For instance, the features may further include processing the first exchange including sending a request, via the network, to a trust engine of an electronic exchange requesting the trust engine to exchange the first amount of the asset including the fractional share into the first corresponding amount of the base currency, the request including an account identifier of the user, the asset identifier, and the first amount of the asset to divest, and receiving, via the network, a response from the trust engine of the electronic exchange that the first exchange of the first amount of the asset including the fractional share for the first corresponding amount of the base currency was successfully completed responsive to sending the request; at least one of the cryptographically signed asset tokens including the unique identifier associated with the user, the asset identifier, a transaction identifier, a market value of the asset at a time of the first exchange, a multiplier value, a timestamp of the reallocation, and a cryptographic signature; processing the second exchange of the investment amount of the deposit value for the second amount of the asset including accessing, via the network, the blockchain ledger to verify a token pool includes a sufficient number of cryptographically signed asset tokens to cover the second exchange, and responsive to positively verifying that the token pool includes the sufficient number of cryptographically signed asset tokens, recording, in the blockchain ledger using the unique identifier associated with the user, an allocation of a number of cryptographically signed asset tokens that correspond to the investment amount of the deposit value; the asset being one of a plurality of assets associated with the user, and determining the first amount of asset to divest further comprising determining, relative to a time of the divestment event, a percentage gain for each of the plurality of assets, and selecting the asset from among the plurality of assets to divest based on a corresponding percentage gain; processing the second exchange of the investment amount of the deposit value for the second amount of the asset including accessing, via the network, the blockchain ledger to determining how many cryptographically signed asset tokens are in a token pool, determining that the token pool includes a portion of the cryptographically signed asset tokens needed to cover the second exchange, recording, in the blockchain ledger using the unique identifier associated with the user, an allocation of the portion of the cryptographically signed asset tokens from the token pool to the account of the user, generating a remaining number of cryptographically signed asset tokens needed to cover the second exchange, and recording, in the blockchain ledger using the unique identifier associated with the user, an allocation of the remaining number of the cryptographically signed asset tokens; the investment event being an electronic deposit of the base currency in the fiat currency account associated with the user at the digital banking system; the divestment event being an electronic preauthorization request for a transaction being processed by a merchant in association with the user; and the asset comprising a public stock or a precious metal.

The features and advantages described herein are not all-inclusive and many additional features and advantages will be apparent in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1A is a block diagram illustrating an example system for fractionalizing and managing objects using a blockchain ledger.

FIG. 1B is a block diagram illustrating a further example system for fractionalizing and managing objects using a blockchain ledger.

FIG. 2 is a block diagram illustrating an example computing device including a token-based asset management engine.

FIG. 3 is a flow diagram illustrating an example method for divesting an asset in accordance with a divestment event.

FIG. 4 is a flow diagram illustrating an example method for investing in an asset in accordance with an investment event.

FIG. 5 is a flow diagram illustrating an example method for exchanging a fractional share of an asset.

FIG. 6 is a flow diagram illustrating an example method for recording asset investment in a blockchain ledger.

FIG. 7 is a flow diagram illustrating an example method for recording asset divestment in a blockchain ledger.

FIG. 8 is a schematic flow diagram illustrating an example method for executing an investment in a portfolio of assets according to an asset investment mix.

FIG. 9 is a schematic flow diagram illustrating an example method for executing a divestment of a portfolio of assets according to an asset investment mix.

FIGS. 10A-10B show example graphical representations of user interfaces for setting up a subaccount for saving funds toward a purchase and using the invested funds to make a purchase.

### DETAILED DESCRIPTION

The technology described in this application beneficially allows, among other things, users to create and use an account in which funds may be deposited and automatically invested in a variety of diverse assets, and via which assets may be automatically divested to provide funds for regular purchases made by a user using various electronic payment methods (e.g., debit, credit, automated clearing house (ACH), electronic funds transfer (EFT), electronic wire, peer-to-peer, etc.). The deposited funds may be automatically invested in a variety of assets according to an asset investment mix to provide the users with savings that appreciate from the investment of the assets. The technology provides the user with access to the variety of assets without requiring the user to create multiple accounts with the respective financial institutions handling the assets.

A user may, using novel interfaces provided by the technology, input settings configuring the investment asset mix in which the technology should invest deposits made in his/her fiat currency account. In a non-limiting example, the investment mix may specify that a certain percentage of the deposited amount should be invested in a certain stock, such as Apple Inc. (AAPL). For instance, Apple may be trading at $113 a share and the deposited amount may be $200, $100 of which is required to be invested in AAPL stock per the settings. However, a traditional stock brokerage is generally incapable of exchanging less than one share/a fractional share of AAPL stock (e.g., these brokerages are generally unable to exchange a fractional (e.g., half, quarter, etc.) share. Advantageously, the blockchain-driven technology disclosed herein is capable of performing such an exchange. In some embodiments, the technology associates each asset with tokens that are created at the time the asset is purchased. Each token is cryptographically signed and includes information about the asset, including the original purchase price. This allows each asset to be broken up into manageable chunks with value that can be handled individually, so that the entire asset purchased doesn't need to be sold at the time that only a portion of its value is needed.

When making purchases, a user may beneficially use the assets to make purchases rather than just funds from the user's bank account. In some embodiments, the assets owned by the user may include fractional shares of the assets. At the time a purchase transaction is initiated (e.g., the user swipes a debit card at a point-of-sale terminal), responsive to receiving the request from the payment processor, the technology is capable of automatically determining which specific amount(s), including fractional amounts, of certain asset(s) to liquidate or divest, if needed, to allow the user to complete a payment for the transaction without any user interaction. As a result, the technology beneficially allows users to use investment assets for day-to-day spending, which were traditionally impractical or unavailable for such uses. The techniques may include various systems, methods, computer program products, interfaces, and other aspects to provide these and other advantages, acts, and/or functionality.

By way of further example, a user may have arranged to have funds automatically deposited into the user's fiat currency account (bank account) from the user's paycheck and uses a debit card (e.g., such as a debit card that uses the existing Mastercard/VISA Interchange) to access his/her assets for purchases. The technology may leave some of the deposited funds available in the bank account in a default fiat currency (US Dollars for US customers) and invest the remaining deposited funds in other assets, such as precious metals, stocks, and cryptocurrencies.

When the user makes a purchase, an authorization request is received to determine whether the user has the funds to make the purchase. The technology can evaluate not only at the fiat currency balance, but the total value of the account, to determine whether or not to authorize the transaction. If the total value of the account is sufficient, the technology sends an authorization response to the requestor. The technology can then automatically divest a needed amount of the investment assets needed to provide the authorized amount of fiat currency for the transaction, if the amount of fiat currency in the user's bank account is itself insufficient to satisfy the transaction. In some cases, the assets for liquidation may be selected based on their relative appreciation with the assets with the highest appreciation since purchase selected first, a user setting specifying the asset(s) to divest, or any other suitable approach.

Advantageously, by using the user's purchases as random events to trigger the sale of certain (e.g., highest performing) asset(s), and regularly investing new funds to rebalance the user's asset mix, the portfolio is capable of performing well even in harsh economic conditions without needing to predict the future performance of any asset.

The technology disclosed herein differs from other automatic investment systems, such as those described in the Background, because divestment is driven by consumption (e.g., day-to-day spending of a user), whereas other investment systems, such as those described in the Background, are designed to focus on the accumulated amount saved for a long-term goal, such as retirement, a house, or a car.

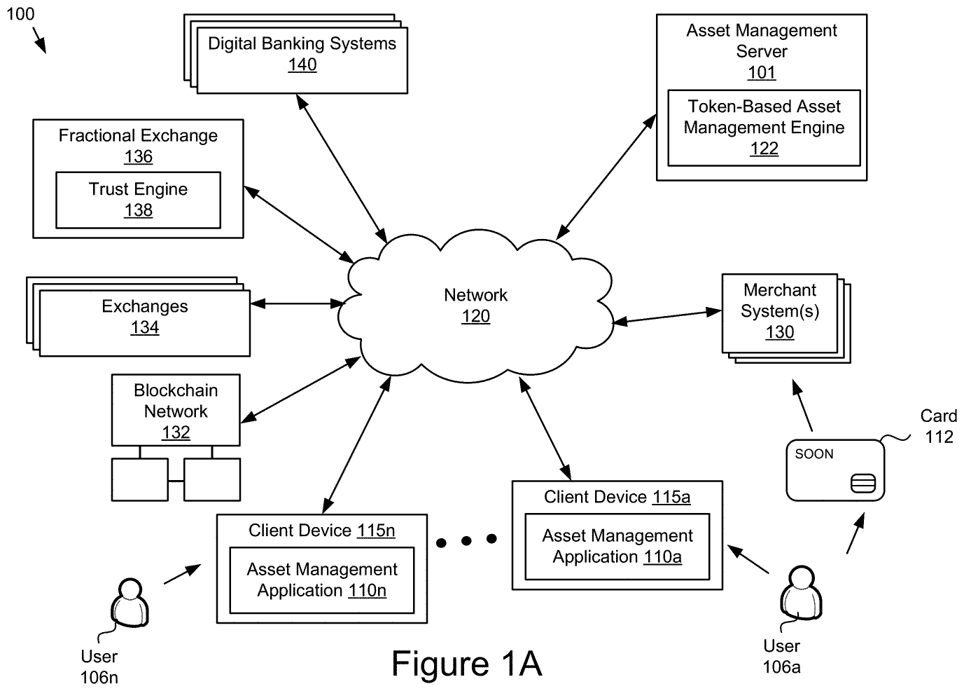

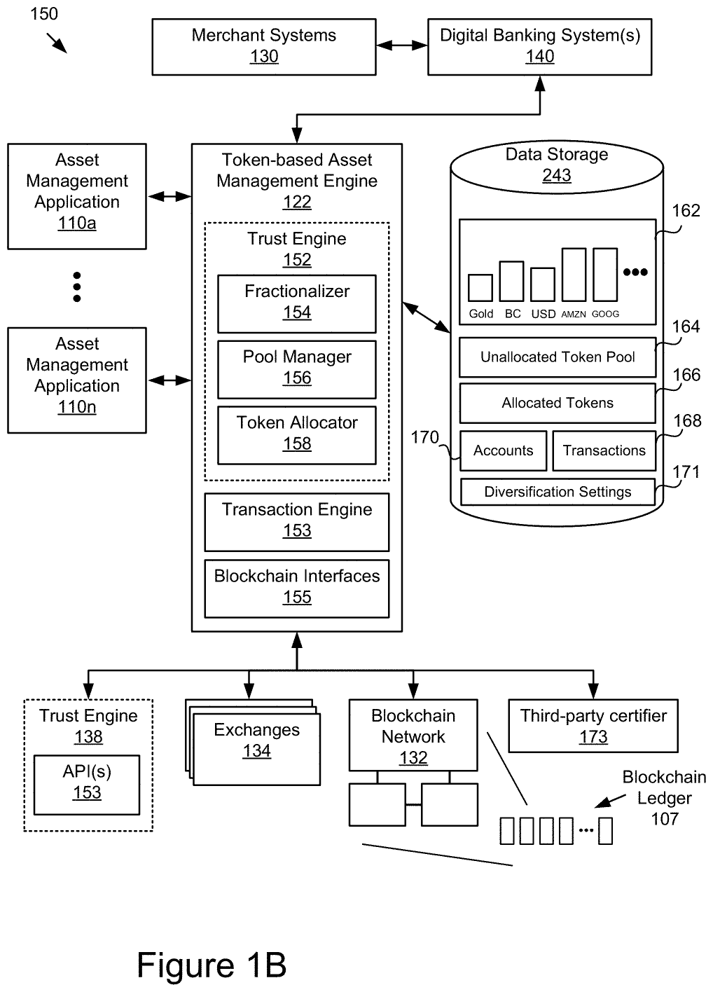

FIG. 1A is a block diagram illustrating an example system 100 for fractionalizing and managing objects using a blockchain ledger. The illustrated system 100 may include client devices 115a . . . 115n, an asset management server 101, merchant system(s) 130, digital banking system(s) 140, exchange(s) 134, a fractional exchange 136, and a blockchain network 132, which are communicatively coupled via a network 120 for interaction with one another. The client devices 115a . . . 115n (also simply referred to as 115) may be accessed by users 106a . . . 106n to manage their portfolio of assets. In FIG. 1 and the other figures, a reference number with a letter suffix (e.g., “a”, “b”, “n”, etc.) represents a specific reference to the element having that particular reference number while a reference number without a suffix represents a general reference to instances of the element bearing that reference number.

As shown, the system 100 may include a client-server architecture, although a variety of different system environments and configurations are contemplated and are within the scope of the present disclosure, such as ones including additional or alternative devices, systems, and networks. For instance, various functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or additional computing devices or systems, etc.

The network 120 may include any number of networks and/or network types. For example, the network 120 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, and/or other interconnected data paths across which multiple devices may communicate, and/or various combinations thereof, etc.

The network 120 may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), ACH, ETF, any other suitable electronic payment protocols, various messaging protocols, or other known protocols.

The client device 115a . . . 115n may be computing devices having data processing and communication capabilities. In some embodiments, a client device 115 may include a memory, a processor (e.g., virtual, physical, etc.), a power source, a network interface, software and/or hardware components, such as a display, graphics processor unit (GPU), wireless transceivers, keyboard, camera (e.g., webcam), sensors, firmware, operating systems, web browsers, applications, drivers, and various physical connection interfaces (e.g., USB, etc.). The client devices 115a . . . 115n may couple to and communicate with one another and the other entities of the system 100 via the network 120 using a wireless and/or wired connection. Examples of client devices 115 may include, but are not limited to, laptops, desktops, tablets, mobile phones (e.g., smartphones, features phones, etc.), server appliances, servers, virtual machines, smart TVs, media streaming devices, user wearable computing devices or any other electronic device capable of accessing a network 120. While two or more client devices 115 are depicted in FIG. 1, the system 100 may include any number of client devices 115. In addition, the client devices 115a . . . 115n may be the same or different type of computing device.

In FIG. 1A, the client device 115a includes an instance of an asset management application 110a. In some embodiments, the asset management application 110 may comprise code operable in a web browser, a web application accessible via a web browser, a native application (e.g., mobile application, installed application, etc.), a peer-to-peer application, a combination thereof, etc. In some embodiments, the asset management application 110 in cooperation with the token-based asset management engine 122 allows the user 106 to create an account with the asset management server 101. The account is configured to link to a fiat currency bank account of the user where the user's funds may be deposited into and spent from to cover transactions with the merchant systems 130 carried out by the user 106. Via the account with the asset management server 101, the token-based asset management engine 122 detects a deposit of funds in the linked fiat currency bank account and invests the deposited funds in a variety of assets without requesting the user 106 to create multiple accounts with different financial institutions holding the assets and associated inconvenience of transferring funds between the multiple accounts.

The asset management server 101 may include one or more computing devices having data processing, storing and network communication capabilities. For example, the asset management server 101 may include one or more hardware servers, virtual servers, server arrays, storage devices and/or systems, etc., and/or may be centralized or distributed/cloud-based. In some embodiments, the asset management server 101 may include one or more virtual servers, which operate in a host server environment and access the physical hardware of the host server including, for example, a processor, a memory, applications, a database, storage, network interfaces, etc., via an abstraction layer (e.g., a virtual machine manager).

In the example of FIG. 1A, the asset management server 101 includes an instance of a token-based asset management engine 122. The asset management server 101 may be operable to manage the portfolio of assets owned by a user, enable an automated investing of deposited funds in a linked fiat currency bank account of the user according to an asset investment mix, and enable an automated divesting of assets in the portfolio to authorize payment for one or more transactions initiated by the user, etc. The asset management server 101 may send data to and receive data from the other entities of the system 100 including the client devices 115, the merchant systems 130, the digital banking systems 140, the exchanges 134, the fractional exchange 136, and the blockchain network 132 via the network 120. It should be understood that the asset management server 101 is not limited to providing the above-noted acts and/or functionality and may include other network-accessible services. In addition, while a single asset management server 101 is depicted in FIG. 1, it should be understood that there may be any number of asset management servers 101, and that the asset management server(s) 101 may be stand-alone servers, included in a server cluster, or take any other suitable form.

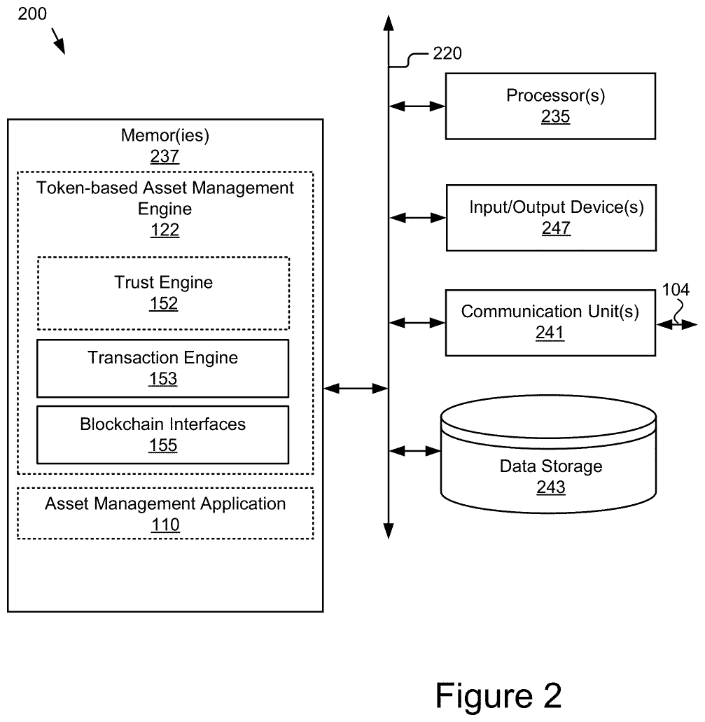

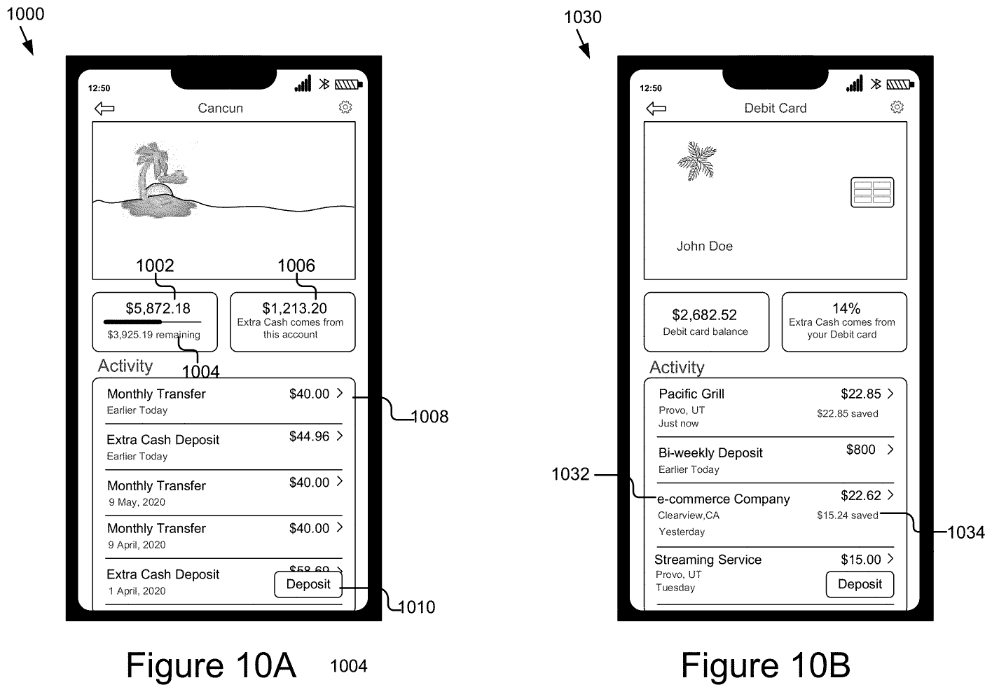

The token-based asset management engine 122 may include software and/or logic to provide the functionality for managing a portfolio of assets including automated investing and/or divesting of the assets using a blockchain ledger. The token-based asset management engine 122 may generate and present various user interfaces to perform these acts and/or functionality, which may in some cases be based at least in part on information received from the asset management server 101, a client device 115, the digital banking systems 140, the merchant systems 130, and other entities of FIG. 1A via the network 120. Non-limiting example user interfaces that may be generated for display by the token-based asset management engine 122 are depicted in FIGS. 10A-10B. Additional structure, acts, and/or functionality of the token-based asset management engine 122 is further discussed below with reference to at least FIGS. 1B and 2.

In the example of FIG. 1A, the digital banking systems 140 may communicate with one or more entities of the system 100, such as the client devices 115, the asset management server 101, the merchant systems 130, the exchanges 134, and the fractional exchanges 136. A digital banking system 140 may be configured to implement an online banking service for authorized users maintaining a bank account with a financial banking institution that is supporting the infrastructure and operation of the digital banking system 140. For example, the bank account may include a checking account, a savings account, a money market account, certificate of deposit (CD) account, a credit card account, etc. In another example, the type of bank account may include a personal bank account, a joint bank account, a business bank account, etc. In some embodiments, the online banking service enables authorized users to handle account management and perform account transactions directly with the bank through the Internet via web, mobile, and/or cloud applications on the one or more client devices 115. The online banking service also allows authorized users to monitor and transfer funds to and from one or more entities of the system 100, such as the exchanges 134. In some embodiments, the digital banking system 140 may be configured to provide or facilitate an application programming interface (API) that provides for integration of banking data with the asset management server 101. For example, the token-based asset management engine 122 in the asset management server 101 may use an API of the digital banking system 140 to connect with a user's bank account managed by the digital banking system 140 and access account information for performing the functionality described herein. The digital banking system 140 securely provides the token-based asset management engine 122 with access to user account information once the user authenticates with the online banking service of the digital banking system 140.

In the example of FIG. 1A, the merchant systems 130 may be configured to implement merchant processing services that enable a business or merchant to accept payment for a transaction through a secure channel using a card 112 of a user 106. For example, the card 112 may be a credit card, a debit card, or a digital wallet implemented on a near-field communication (NFC)-enabled device or other-proximity-based communication technology (e.g., radio-frequency identification (RFID)). In further examples, the card may comprise a contact-based card, such as a smart card, a card having a magnetic stripe, or another suitable card technology. In some embodiments, the card 112 may be issued to the user 106 by a financial banking institution providing financial services through the digital banking system 140. In some embodiments, the card 112 may be issued to a user 106 by a stakeholder of the asset management server 101. In some embodiments, the merchant systems 130 may operate as an intermediary (e.g., merchant service provider) between the digital banking systems 140, a person or organization wanting to receive funds, and the person or organization looking to purchase goods or services. For example, the merchant systems 130 may facilitate the transfer of funds from a user's bank account to a retailer's bank account when a transaction is authorized by the user 106 using the card 112. The merchant processing services may include, but not limited to, credit or debit card payment processing, automated clearing house, payment gateway, online transaction processing, point of sale systems, etc.

In the example of FIG. 1A, the exchanges 134 may refer to online investing brokerage firms and trading platforms that facilitate buying and selling of financial instruments, products or assets on a trading exchange. In some embodiments, the exchanges 134 may be configured as cloud-based and API-driven investment management entities that cooperate with and enable the asset management server 101 to create entity accounts to invest and/or divest user funds in a plurality of assets. Examples of a financial instrument or asset may include stocks, bonds, currencies, cryptocurrency, commodities (e.g., gold, silver, agricultural products, raw materials, etc.), derivatives, real estate, option contracts, loans, certificates of deposit, treasury bills, exchange-traded funds, mutual funds, art, collectibles, etc.

In the example of FIG. 1A, the fractional exchange 136 may refer to a fractional share investing brokerage firm that facilitates buying and selling of partial shares of an asset, such as a stock, gold, silver, etc. For example, major stock exchanges, such as the New York Stock Exchange® require a purchase of at least one share of an asset at a time. A fractional share investing brokerage firm may buy whole shares of the asset, divvy them into partial-share increments known as “fractional shares” and enable users to buy and/or sell the fractional shares of the asset. For example, a user may buy or sell a fractional share of an asset for as little as $5 in a single trade. In the example implementation of FIG. 1, the fractional exchange 136 is configured to implement a trust engine 138.

In the example of FIG. 1A, the blockchain network 132 may be defined as a technical infrastructure that provides ledger and smart contract services to other entities of FIG. 1A, such as the asset management server 101, the exchanges 134, the fractional exchange 136, and the asset management application 110 on the client device 115. The blockchain network 132 maintains a continuously growing list of transactions and data records that are cryptographically secure. In an example blockchain network 132, smart contracts are used to generate the transactions and the blockchain network 132 distributes the transactions to peer nodes in the network where the transactions get immutably recorded on a copy of the ledger maintained by every peer node. The blockchain network 132 may comprise any suitable type of blockchain, such as public (e.g., Bitcoin, Ethereum, Litecoin, NEO, etc.), private (Hyperledger Fabric, Quorum, Ripple, etc.), hybrid (e.g., Orbs, etc.), and/or federated. Further, while the blockchain network 132 is depicted as a single entity, it may include any number of blockchains and/or types of blockchain.

It should be understood that the system 100 illustrated in FIG. 1A is representative of an example system for managing a portfolio of assets including automated investing and/or divesting of the assets using a blockchain ledger, and that a variety of different system environments and configurations are contemplated and are within the scope of the present disclosure. For instance, various functionality may be moved from a server to a client device, or vice versa and some embodiments may include additional or fewer computing devices, services, and/or networks, and may implement various functionality client or server-side. Further, various entities of the system 100 may be integrated into to a single computing device or system or additional computing devices or systems, etc.

FIG. 1B is a high-level block diagram illustrating a further example system 150 for fractionalizing and managing objects using a blockchain ledger. FIG. 1B shows an example of the general data flow between the token-based asset management engine 122 in the asset management server 101 and other entities depicted in FIG. 1A to manage a set of objects (in this case a portfolio of assets) including automated investing and/or divesting of the assets using the blockchain network 132.

FIG. 2 is a block diagram illustrating a computing device 200. The example computing device 200 may represent the computer architecture of a user's client device 115, an asset management server 101, a fractional exchange 136, and/or a node of the blockchain network 132. A client device 115, the asset management server 101, the fractional exchange 136, and/or the node of the blockchain network 132 may include additional and/or different software and/or hardware components depending on the implementation. However, it should be understood that the computing device 200 may take other forms and include additional or fewer components without departing from the scope of the present disclosure. For example, while not shown, the computing device 200 may include sensors, additional processors, and other physical configurations.

For instance, in a client-server embodiment, a client device 115 may include an instance of the asset management application, and the asset management server 101 may include an instance of the token-based asset management engine 122. In a peer-to-peer embodiment, client devices 115 may include instances of the asset management application and the asset management server 101. In an edge-server embodiment, the asset management servers 101 may include instances of the token-based asset management engine 122 located in various different geographic regions, etc. As shown, a computing device 200 may include an instance of the token-based asset management engine 122 and/or the asset management application 110, depending on the configuration.

The computing device 200 may also include processor(s) 235, memor(ies) 237, communication unit(s) 241, input/output device(s) 247, and a data storage 243, according to some examples. The components of the computing device 200 may be electronically communicatively coupled by a communications bus 220. The communication bus 220 may include a bus for transferring data and signals between components of a computing system or between computing systems, a network bus system including the network 120 or portions thereof, a processor mesh, a combination thereof, etc. In some embodiments, the components of the system 100 may cooperate and communicate via a communication mechanism included in or implemented in association with the bus 220. The software communication mechanism may include and/or facilitate, for example, inter-method communication, local function or procedure calls, remote procedure calls, an object broker (e.g., common object request broker architecture (CORBA)), direct socket communication (e.g., TCP/IP sockets) among software modules, UDP broadcasts and receipts, HTTP connections, etc. Further, any or all of the communication could be secure (e.g., secure shell (SSH), HTTPS, etc.).

The processor(s) 235 may have various computing architectures to method data signals including, for example, a complex instruction set computer (CISC) architecture, a reduced instruction set computer (RISC) architecture, and/or an architecture implementing a combination of instruction sets. The processor(s) 235 may be physical and/or virtual and may include a single core or plurality of processing units and/or cores.

A processor 235 may execute software instructions, such as the operations, acts, and functions described herein, by performing various input, logical, and/or mathematical operations. For example, operations performed by a computing device including “processing,” “computing,” “retrieving,” “calculating,” “determining,” “displaying,” or others identified in the methods described herein, may refer to the action and processes of the computing device 200, or similar electronic computing device, that manipulates and transforms data represented as physical (electronic) quantities within the computer system's registers and memories into other data similarly represented as physical quantities within the computer system memories or registers or other such information storage, transmission or display devices.

In some embodiments, a processor 235 may be capable of generating and providing electronic display signals to a display device, supporting the display of images, capturing and transmitting images, performing complex tasks including various types of feature extraction and sampling, etc. In some embodiments, the processor(s) 235 may be coupled to the memory/ies 237 via the bus 220 to access data and instructions therefrom and store data therein. The bus 220 may couple the processor(s) 235 to the other components of the computing device 200 including, for example, the communication unit(s) 241, the memory/ies 237, the input/output device(s) 247, and/or any other components, such as other suitable components and/or computing systems.

The memory/ies 237 may include non-transitory computer-usable (e.g., readable, writeable, etc.) media, which can be any non-transitory apparatus(es) or device(s) that can contain, store, communicate, propagate or transport instructions, data, computer programs, software, code, routines, etc., for processing by or in connection with the processor(s) 235. In some embodiments, the memory/ies 237 may include one or more of volatile memory and non-volatile memory (e.g., read-only memories (ROMs), random access memories (RAMs), erasable programmable ROMs (EPROMs), electrically erasable programmable ROMs (EEPROMs), flash memories, solid-state memories, hard disks, magnetic or optical cards, optical disks, etc.), or any other type of media suitable for storing electronic instructions and/or data. It should be understood that the memory(ies) 237 may be a single device or may include multiple types of devices and configurations.

In some embodiments, the memor(ies) 237 may store instructions and/or data that may be executed by the processor 235. The instructions and/or data may include code for performing the techniques described herein. For example, as depicted in FIG. 2, the memory 237 may store an instance of the token-based asset management engine 122 and/or the asset management application 110. The memor(ies) 237 are also capable of storing other instructions and data, including, for example, an operating system, hardware drivers, other software applications, databases, etc. The memor(ies) 237 may be coupled to the bus 220 for communication with the processor(s) 235 and the other components of the computing device 200.

The input/output (I/O) device(s) 247 may include any device for inputting or outputting information to or from the computing device 200 and may be coupled to the computing device 200 either directly or through intervening I/O controllers. Non-limiting example I/O devices 247 include a touchscreen or any other similarly equipped display device used to display user interfaces, electronic images, and data as described herein in various colors and shades, a keyboard (e.g., a QWERTY keyboard), a pointing device (e.g., a mouse or touchpad), a touchscreen, a microphone, an audio reproduction device (e.g., speaker), an image/video capture device (e.g., camera), a scanner, a barcode reader, and any other I/O components for facilitating communication and/or interaction with users.

Communication unit(s) 241 may include one or more interface devices (UF) for wired and wireless connectivity among the components of the system 100. For instance, the communication unit(s) 241 may include various types known connectivity and interface options. Wireless (e.g., Wi-Fi™) transceivers, Ethernet adapters, and modems, are just a few examples of interface devices.

Communication unit(s) 241 may be coupled to the other components of the computing device 200 via the bus 220. Communication unit(s) 241 may be electronically communicatively coupled to the network 120 (e.g., wiredly, wirelessly, etc.). In some embodiments, the communication unit(s) 241 can link the processor(s) 235 to the network 120, which may in turn be coupled to other processing systems. The communication unit(s) 241 can provide other connections to the network 120 and to other entities of the system 100 using various standard communication protocols.

The data storage 243 is a non-transitory memory that stores data for providing the functionality described herein. In some embodiments, the data storage 243 may be coupled to the components 235, 237, 241, and 247 via the bus 220 to receive and provide access to data. In some embodiments, the data storage 243 may store data received from other elements of the system 100 include, for example, the merchant systems 130, the digital banking systems 140, the exchanges 134, the asset management application 110 and/or the token-based asset management engine 122, and may provide data access to these entities. The data storage 243 may store, among other data, unallocated token pool 164, allocated tokens 166, accounts 170, transactions 168, and diversification settings 171.

The data storage 243 is an information source for storing and providing access to various data. The token-based asset management engine 122 and/or the asset management application 110 may be coupled to retrieve, generate, and/or store any applicable data in the data storage 243. The data storage 243 may be configured to store, manage, and provide access to any of the applicable data and data types discussed herein.

The data storage 243 may be included in the computing device 200 or in another computing device and/or storage system distinct from but coupled to or accessible by the computing device 200. The data storage 243 may include one or more non-transitory computer-readable mediums for storing the data, such as those discussed herein with respect to the memory(ies) 237. In some embodiments, the data storage 243 may be incorporated with the memory(ies) 237 or may be distinct therefrom.

The data storage 243 may be organized and queried using various criteria including any type of data stored by them, such as unique identifiers, timestamps, textual and/or graphical content, entity characteristics, etc., as discussed in further detail herein. In some embodiments, the data storage 243 may include data tables, relational/semi-structured/graph/etc., databases, key/value pair lists, or other organized or unorganized collections of data, although any data object types, storage structure and/or organizational scheme may be utilized to store and manage data in the data storage 243. For instance, the data storage 243 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

As depicted in FIG. 2, the token-based asset management engine 122 may include a trust engine 152, a transaction engine 153, and blockchain interfaces 155. The token-based asset management engine 122, the components thereof, and/or the asset management application 110 may each include software and/or logic executable to provide their respective functionality.

In some embodiments, the token-based asset management engine 122, the components thereof, and/or the asset management application 110 may be executable by the processor(s) 235 to provide their acts and/or functionality. In some embodiments, the token-based asset management engine 122, the components thereof, and/or the asset management application 110 may each be implemented using programmable or specialized hardware including a field-programmable gate array (FPGA) or an application-specific integrated circuit (ASIC). In some embodiments, the token-based asset management engine 122, the components thereof, and/or the asset management application 110 may each be implemented using a combination of hardware and software executable by the processor(s) 235. Other suitable variations are also possible and contemplated.

In some embodiments, the components 122 and 110 may each be adapted for cooperation and communication with the processor(s) 235, the memory(ies) 237, and with each other via the bus 220. The components 122 and 110 may send and receive data, via the communication unit(s) 241, to and from one or more of the client devices 115, the asset management server 101, the merchant systems 130, the digital banking systems 140, the exchanges 134, the fractional exchange 136 and the blockchain network 132.

Referring back to FIG. 1B, the asset management applications 110a . . . 110n (also simply referred to as 110) cooperate with the token-based asset management engine 122 to set up an account for users 106a . . . 106n (also simply referred to as 106) with the asset management server 101, among other things. The asset management application 110 may include software and/or logic to provide functionality for facilitating a registration of a user 106 with the asset management server 101 to access the acts and/or functionality described herein. For example, to access various acts and/or functionality provided by the asset management server 101, the asset management application 110 may allow a user to create an account with the asset management server 101 by requesting login credentials to register and/or authenticate the user. For example, the login credentials requested may include a username and password, and physical or human biometric information. Account data 170 defining the account the registered user may include any information for the account including unique account identifier(s), user information, a unique user identifier, account and sub-account information including names, numbers, balances, etc.), and so forth. For simplicity, account data and the user's account may be referenced interchangeably as account 170 herein.

The asset management application 110 may also request onboarding information required by various regulations, such as financial regulations. The asset management application 110 allows the user to link a fiat currency bank account (e.g. personal checking account) to their account with the asset management server 101 by requesting login credentials that authenticate their identity with the online banking service at the digital banking system 140. The asset management application 110 cooperates with the token-based asset management engine 122 to provide the user 106 with feedback about their portfolio of assets. For example, the feedback may include information relating to growth or appreciation of assets in the portfolio and amount saved due to use of the asset appreciation to cover a purchase made by the user.

In the example of FIG. 1B, the token-based asset management engine 122 may include a trust engine 152, a transaction engine 153, and blockchain interfaces 155. The transaction engine 153 may include software and/or logic to provide functionality for receiving and processing events, managing an exchange of funds and assets in an investment or divestment event associated with the account 170 of the user.

The transaction engine 153 is configured to receive electronic authorization requests from the digital banking systems 140 for purchase transactions, process the requests, and provide or decline the requests based on users' liquid and illiquid assets managed at least in part by the token-based asset management engine 122. The transaction engine 153, based on information stored in the data storage 243, from the trust engine 152, from the exchanges 134, and/or other information sources, may automatically determine which specific amount(s), including fractional amounts, of certain asset(s) to liquidate or divest, if needed, to allow the user to complete a payment for the transaction without any user interaction.

As discussed further elsewhere herein, the transaction engine 153 may determine the asset mix to maintain for each user, and as part of that mix, may maintain a portion of a user's funds in the user's fiat currency account in a default fiat currency (US Dollars for US customers) and automatically invest in and divest from other assets, such as precious metals, stocks, and cryptocurrencies based on the user's spending. The transaction engine may store and maintain each user's accounts information as accounts data 170 in the data storage 243 and may store and maintain transaction records for purchases made by the user as transactions data 168 in the data storage 243.

In some embodiments, the transaction engine 153 may receive event data from the digital banking system 140 reflecting an investment event in association with the account 170 of the user. For example, the investment event may include a detection of an electronic deposit of funds, such as a paycheck in base currency in a linked fiat currency account (e.g., personal checking account) of the user at the bank. The transaction engine 153 stores the investment event involving depositing of funds into linked fiat currency account as transactions data 168 in the data storage 243. The transaction engine 153 uses the investment event involving depositing of funds into linked fiat currency account to signal the trust engine 152 and initiate investing of new funds to rebalance the asset investment mix of the user. The transaction engine 153 retrieves the estimated fixed expenses of the user from a database storing diversification settings, such as the diversification settings 171 in the data storage 243, and determines how much of the deposited funds is to be left in the linked fiat currency account for covering the fixed expenses. The transaction engine 153 determines the amount of the deposited funds remaining after deduction of the fixed expenses as the investable amount (i.e., investment amount of deposit value) available for investing in one or more assets of the user portfolio according to the asset investment mix. The transaction engine 153 sends the value of the investable amount to the fractionalizer 154.

In some embodiments, the transaction engine 153 may access the user's linked fiat currency bank account to retrieve transaction history over a period of time (e.g., past 6 months). The transaction engine 153 may analyze the transaction history to determine an estimated budget for fixed expenses and an estimated income of the user. For example, the estimates determined for fixed expenses and income of the user may be per day, per week, per month, per year, etc. In some embodiments, the transaction engine 153 may receive user input via the asset management application 110 to adjust the estimates for fixed expenses and income of the user. The transaction engine 153 repeats the process of retrieving and analyzing transaction history to generate estimates for fixed expenses and income at regular intervals to improve accuracy over time. In some embodiments, the transaction engine 153 determines a difference between the estimated fixed expenses and the estimated income as an investment rate. For example, the investment rate defines a percentage of the estimated income that is available for investing in one or more assets of the portfolio.

In some embodiments, the transaction engine 153 may receive user input via the asset management application 110 to adjust or revise the asset allocation in the asset investment mix. For example, the asset management application 110 may present a set of questions to ask the user about their investment goals and strategies. The questions may include age, education level, employment, income, risk tolerance, comfort level with various asset types, criteria for selecting and investing in assets (e.g., environmental, social, corporate governance, etc.), etc. The transaction engine 153 receives data including answers to the questions from the user via the asset management application 110 and analyzes the answers to the set of questions from the user to determine an asset investment mix of the assets for the account 170 of the user. For example, the asset investment mix defines asset allocation in terms of percentage allocated for stocks (40%), bonds (10%), cash (5%), cryptocurrency (15%), gold (25%), silver (5%), etc.

The transaction engine 153 may further generate and store data defining a mix for a particular asset class. For example, the basic mix for stocks may be further broken down into a mix of industry sectors, such as technology, banking, transportation, manufacturing, etc. In some embodiments, the transaction engine 153 stores the asset investment mix, estimated income, estimated expenses, and the investment rate for the account 170 of the user under diversification settings 171 in the data storage 243. In some embodiments, the transaction engine 153 identifies one or more entities (e.g., exchanges 134, fractional exchange 136, etc.) handling the assets identified in the asset investment mix and creates a For Benefit Of (FBO) account or other suitable account (referred to herein as entity accounts) with each entity for the user. For example, the entities may include a brokerage firm, a digital cryptocurrency exchange, a commodities exchange, an investment bank, etc. The entity account may allow the user to buy, hold, and sell shares of the associated asset in any amount. The entity account may also be established with a third-party trust entity (e.g., fractional exchange 136) that can hold whole shares of an asset, such as a stock, and allocate fractional shares to individual users in their entity account.

The transaction engine 153 may associate the unique account information of the entity account with the user (e.g., using a unique user account identifier, user identifier, other suitable key, etc.) in the account data 170 stored in the data storage 243. In some embodiments, the transaction engine 153 may be configured to transfer funds between the linked fiat currency account of the user and the various entity accounts for initiating purchases and/or sales of the associated assets in the entity accounts. In some embodiments, the functionality of the asset management application 110 may be implemented by and executed fully or partially by the transaction engine 153.

In the implementation where the asset management server 101 is configured to serve as a trust entity, the trust engine 152 may be included in the token-based asset management engine 122. The trust engine 152 may include software and/or logic to provide functionality for facilitating purchasing, holding, and issuing one or more assets to users. In some embodiments, the trust engine 152 cooperates with the exchanges 134 and 136 to purchase a variety of assets and represents the purchased assets as cryptographically signed asset tokens in the unallocated token pool 164 in the data storage 243. The trust engine 152 uses the unallocated token pool 164 to service deposits made by the user based on the account data 170 of the user and allocates cryptographically signed asset tokens representing the purchased assets of the user in a blockchain ledger 107. In some embodiments, the cryptographically signed asset tokens may be created at the time of purchase of the corresponding asset. This allows an asset purchased to be broken up into manageable chunks or blocks and made readily accessible to components of the token-based asset management engine 122. For example, each chunk or block is represented by a cryptographically signed asset token. Each cryptographically signed asset token has value that can be handled individually in an investment event or a divestment event associated with the account of the user. For example, the representation and tracking of an asset using a plurality of cryptographically signed asset tokens in the blockchain ledger 107 may not necessitate investing in and/or divesting of the entire asset when a portion of the asset is sufficient.

In some embodiments, the trust engine 152 may include a fractionalizer 154, a pool manager 156, and a token allocator 158. In some embodiments, the fractionalizer 154 may include software and/or logic to provide functionality for determining an asset to acquire (or sell) and an amount of the asset to acquire (or sell).

In some embodiments, the fractionalizer 154 queries and retrieves the diversification settings 171 including the asset investment mix for the account of the user from the account data 170 in the data storage 243. For example, the asset investment mix includes set percentages allocated for each asset, such as 25% for stock A, 25% for stock B, 20% for cash, 20% for cryptocurrency, and 10% for gold. In some embodiments, the fractionalizer 154 determines an amount or quantity of an asset to acquire based on the asset investment mix and the investable amount. For example, if $1000 is the investable amount, then the fractionalizer 154 determines $250 from $1000 as the amount to invest in stock A. The fractionalizer 154 determines a current market value for stock A is $2500. The fractionalizer 154 divides the amount to invest ($250) in stock A by the current market value ($2500) of stock A to determine an amount (e.g., 0.1 fractional share) of the asset stock A to acquire. The fractionalizer 154 similarly determines the amount of an asset to acquire for the other assets in the asset investment mix.

In some embodiments, the fractionalizer 154 determines how much of the investable amount is to be invested in each one of the assets based on the asset investment mix and a current balance of the each one of the assets in the portfolio of the account of the user. The fractionalizer 154 allocates a portion of the investable amount in each one of the assets in such a way so as to bring the asset allocation in the asset investment mix to a targeted asset mix. For example, if the balance in the account (as reflected by the user's account data 170) indicates that $1000 in non-cash assets is allocated as $300 in gold, $100 in silver, $400 in stocks, and $200 in cryptocurrency, and an investable amount of $500 is available for investing, the fractionalizer 154 allocates an additional $75 to purchase gold, $350 to purchase silver, $50 to purchase stocks, and $25 to purchase cryptocurrency to bring the total asset allocation to the targeted asset mix of 25% gold, 30% silver, 40% stocks, and 15% cryptocurrency. In some embodiments, the fractionalizer 154 sends instructions to the transaction engine 153 to transfer the investable amount from the linked fiat currency account of the user to the pool manager 156 in the trust engine 152 for facilitating the purchase of a determined amount of each asset included the asset investment mix.

In some embodiments, the transaction engine 153 receives event data from the digital banking system 140 reflecting a divestment event in association with the account of the user. For example, the divestment event may include a payment made by the user for a transaction with a merchant using the card 112. The merchant systems 130 receive and process data including the card information from the merchant and send an electronic preauthorization request for the transaction to the banking institution of the user at the digital banking system 140. The banking institution at the digital banking system 140 routes the preauthorization request to the transaction engine 153. The transaction engine 153 stores the divestment event involving a user's payment for a transaction under transactions 168 in the data storage 243. In some embodiments, the transaction engine 153 uses the divestment event involving a user's payment for a transaction to signal the trust engine 152 and initiate divesting of an asset in the portfolio of the user such that at least a portion of the payment for the transaction is covered with the divested asset. The transaction engine 153 determines a transaction value (e.g., debit amount for payment in base currency) from the preauthorization request and sends the transaction value to the fractionalizer 154.

In some embodiments, the transaction engine 153 determines whether an available balance in the fiat currency account of the user is sufficient to cover the transaction value. If it is sufficient, the transaction engine 153 sends instructions to the digital banking system 140 to place a hold on the corresponding amount in the fiat currency account to cover the payment for the transaction. The transaction engine 153 then sends an authorization message to the merchant authorizing the payment. If it is insufficient, the transaction engine 153 evaluates the portfolio of assets associated with the account of the user. In some embodiments, the transaction engine 153 accesses the blockchain ledger 107 using a unique identifier associated with the account of the user to verify and evaluate the portfolio of assets associated with the account of the user. The blockchain ledger 107 holds cryptographically signed asset tokens representing the portfolio of assets associated with the account of the user. The transaction engine 153 evaluates the portfolio of assets and their current value in base currency based on current market prices of the assets in the portfolio. If the available balance in the fiat currency account of the user and the current value of the portfolio of assets is sufficient to cover the payment for the transaction, in some embodiments, the transaction engine 153 places a hold on the portfolio of assets and signals the trust engine 152 to divest a portion of the assets in the portfolio until sufficient base currency is accumulated to cover a difference between the available balance in the fiat currency account and the transaction value.

In some embodiments, the fractionalizer 154 uses the asset investment mix for the account of the user and the transaction value to determine an amount of an asset to divest. For example, the asset investment mix may include percentage asset allocation, such as 25% for stock A, 25% for stock B, 20% for cash, 20% for cryptocurrency, and 10% for gold. For example, if $100 is the transaction value, then the fractionalizer 154 determines $25 as the amount to divest from stock A. The fractionalizer 154 determines that a current market value for stock A is $2550. The fractionalizer 154 divides the amount to divest ($25) from stock A by the current market value ($2550) of stock A to determine a quantity or amount (e.g., 0.009804 of fractional shares) of the asset stock A to divest. The fractionalizer 154 similarly determines the amount of the asset to divest for the other assets in the asset investment mix.

In some embodiments, the fractionalizer 154 accesses the blockchain ledger 107, evaluates the portfolio of assets for the account of the user in the blockchain ledger 107, and selects an asset for divesting based on its relative appreciation since purchase of that asset. For example, the fractionalizer 154 selects an asset having the highest appreciation amongst the portfolio of assets for divesting to cover the transaction value or a portion of the transaction value. In some embodiments, the fractionalizer 154 retrieves a current market value 162 of the portfolio of assets against base currency relative to the time of divestment event (e.g., at the time of the transaction initiated by the user) from the data storage 243. The fractionalizer 154 determines the percentage gain of each asset from their original purchase price and ranks the assets in the portfolio by their percentage gain. For example, the fractionalizer 154 may calculate each asset's percentage gain from its current values and its original purchase price and then rank the assets in the portfolio from highest to lowest percentage gain and may select the asset with highest percentage gain for divesting, although other ranking and selection criteria may be used and are contemplated.

If divesting of this first selected asset is insufficient to cover the payment corresponding to the transaction value, the fractionalizer 154 selects the next asset according to the selection criteria (e.g., with the second highest percentage gain) for further divesting.

In another example having different selection criteria, the fractionalizer 154 may be configured to select an asset in a portfolio for divesting based on how long it has been since a date of purchase. For example, the fractionalizer 154 may rank the assets in the portfolio from longest-held asset to shortest-held asset. The fractionalizer 154 prioritizes selecting and divesting a longest-held asset (e.g., held for more than a year) from the portfolio. In some embodiments, the fractionalizer 154 sends instructions to the pool manager 156 to purchase the determined amount of the asset from the user and deposit the exchanged funds in base currency in the linked fiat currency account. The transaction engine 153 facilitates the deposit of exchanged funds from the pool manager 156 to the linked fiat currency account from the divesting of assets in the portfolio.

In some embodiments, the pool manager 156 may include software and/or logic to provide functionality for processing a first exchange of one or more assets into funds and a second exchange of funds into one or more assets. In some embodiments, the pool manager 156 represents and tracks the assets purchased and/or sold in the system 150 as cryptographically signed asset tokens in a blockchain ledger 107. When an asset is purchased, the purchased asset is broken into smaller blocks. Each block is represented by a cryptographically signed asset token. In some embodiments, the pool manager 156 manages an unallocated token pool 164 in the blockchain ledger 107. The unallocated token pool 164 may be associated with the asset management server 101 and contains cryptographically signed asset tokens for a variety of assets that were previously purchased by the asset management server 101 as a buffer or a leftover of assets that were previously purchased to cover an investment event including a deposit. In some embodiments, the pool manager 156 maintains a copy of the unallocated token pool 164 in the data storage 243.

In the context of an investment event, the pool manager 156 receives an identifier of one or more selected assets in the asset investment mix associated with the user and an amount of each of the one or more selected assets to process for acquiring from the fractionalizer 154. In some embodiments, the pool manager 156 exchanges the investable amount transferred from the linked fiat currency account of the user for a purchase of a determined amount of each asset according to the asset investment mix. The pool manager 156 determines a number of cryptographically signed asset tokens to allocate to an account of the user (as reflected in the user's account data 170) in the blockchain ledger 107 using the amount or quantity of the purchased asset (not the value in base currency) as input. For example, if the amount of a purchased asset is 7.1 shares, the pool manager 156 multiples the amount of the purchased asset by 1,000,000. The resulting number 7,100,000 represents the number of cryptographically signed asset tokens corresponding to the purchased asset needed to allocate to an account of the user in the blockchain ledger 107. A portion of the number of cryptographically signed asset tokens may represent a fractional share of an asset.

In some embodiments, the pool manager 156 may access the blockchain ledger 107 to determine whether the asset management server 101 (acting as a trust entity) owns a sufficient amount of the identified asset that is not previously allocated. For example, the pool manager 156 accesses the blockchain ledger 107 to determine how many cryptographically signed asset tokens corresponding to the purchased asset are present in the unallocated token pool 164.

The pool manager 156 may verify whether the unallocated token pool 164 includes a sufficient number of cryptographically signed asset tokens for the purchased asset. If the unallocated token pool 164 is positively verified to include the sufficient number of cryptographically signed asset tokens, in some embodiments, the pool manager 156 places a hold on the determined number of cryptographically signed asset tokens corresponding to the purchased asset in the unallocated token pool 164.

The pool manager 156 may send instructions to the token allocator 158 to record an allocation of the determined number of cryptographically signed asset tokens corresponding to the purchased asset held from the unallocated token pool 164 to the account of the user in the blockchain ledger 107. If the unallocated token pool 164 is determined to include some portion of the determined number of cryptographically signed asset tokens corresponding to the purchased asset, the pool manager 156 may place a hold on the available portion of the determined number of cryptographically signed asset tokens in the unallocated token pool 164 and sends instructions to the token allocator 158 to record an allocation of the portion of the determined number of cryptographically signed asset tokens held from the unallocated token pool 164 to the account of the user in the blockchain ledger 107. The pool manager 156 may then cooperate with one or more of the exchanges 134 and 136 to purchase one or more additional units (e.g., shares) of the under-purchased asset for the asset management server 101 serving as a trust entity, may generate a corresponding number of cryptographically signed asset tokens based on the purchase, and add them to the unallocated token pool 164 as replenishment. The pool manager 156 may proceed to send instructions to the token allocator 158 to record an allocation of the remaining portion of the determined number of cryptographically signed asset tokens corresponding to the purchased asset held from the replenished unallocated token pool 164 to the account of the user in the blockchain ledger 107.

In the context of a divestment event, the pool manager 156 may receive an identifier of one or more selected assets from the portfolio associated with the user and an amount of each of the one or more selected assets to process for exchange into base currency from the fractionalizer 154. In some embodiments, the pool manager 156 may use a unique identifier associated with the account of the user and the asset identifier identifying the selected asset to access the blockchain ledger 107 and verify that an amount of the selected asset is available for the user to divest. The pool manager 156 may determine a number of cryptographically signed asset tokens corresponding to the amount of the selected asset targeted for divestment.

If the account of the user (as reflected by the user's account data 170) is positively verified to include the sufficient number of cryptographically signed asset tokens of a selected asset in the blockchain ledger 107 for divesting, the pool manager 156 may exchange an amount of the selected asset into an amount of base currency to transfer to the linked fiat currency account of the user. For example, the pool manager 156 may purchase the amount of the selected asset from the user and deposits the exchanged amount of base currency in the linked fiat currency account of the user. The pool manager 156 may identify the number of cryptographically signed asset tokens corresponding to the divested asset to reallocate from the account of the user in the blockchain ledger 107 to the unallocated token pool 164. For example, if the amount of a divested asset is 2.3 shares, the pool manager 156 may multiply the amount of the divested asset by a certain number, such as 1,000,000 (although any other suitable multiplier may be used). In this example, the resulting number 2,300,000 represents the number of cryptographically signed asset tokens corresponding to the divested asset needed to be reallocated from the account of the user to the unallocated token pool 164 in the blockchain ledger 107. The pool manager 156 may send instructions to the token allocator 158 to record a reallocation of the determined number of cryptographically signed asset tokens from the account of the user to the unallocated token pool 164 in the blockchain ledger 107. In some embodiments, the pool manager 156 may destroy the number of cryptographically signed asset tokens corresponding to the divested asset.

In some embodiments, the token allocator 158 may include software and/or logic to provide functionality for recording the investment and/or divestment of one or more assets in the blockchain ledger 107. The token allocator 158 may receive data including a determined number of cryptographically signed asset tokens corresponding to a processed asset for allocation or reallocation, an asset identifier of the processed asset, and a unique identifier of the user to associate the determined number of cryptographically signed asset tokens in the blockchain ledger 107 from the pool manager 156. In the context of an investment event, the token allocator 158 may be configured to record the allocation of the number of cryptographically signed asset tokens corresponding to the purchased asset from the unallocated token pool 164 to the account of the user in the blockchain ledger 107. The token allocator 158 may decrease a balance of a number of cryptographically signed asset tokens corresponding to a purchased asset in the unallocated token pool 164 accordingly based on recording the allocation. In some embodiments, the token allocator 158 stores and tracks allocation under the allocated tokens 166 in the data storage 243. In the context of a divestment event, the token allocator 158 is configured to record the reallocation of the number of cryptographically signed asset tokens corresponding to the divested asset from the account of the user to the unallocated token pool 164 in the blockchain ledger 107. The token allocator 158 may replenish a balance of a number of cryptographically signed asset tokens corresponding to a divested asset in the unallocated token pool 164 accordingly based on recording the reallocation. A cryptographically signed asset token recorded by the token allocator 158 in the blockchain ledger 107 may include information about the corresponding asset, such as an identifier of the asset, (e.g. gold, silver, stock, etc.), an amount of the asset (e.g. 0.001 oz. of gold, 0.02 shares of a stock, etc.), a unique identifier associated with the user (e.g., an identifier of the user's account 170), a market value of the asset token in base currency at the time of purchase (e.g. $1.153), a current market value of the asset token, a multiplier value, a transaction identifier, a timestamp of the allocation (and/or reallocation as the case may be), a cryptographic signature, a blockchain ledger link, an entity (e.g., FBO) account number, etc.

In an implementation where the asset management server 101 is not configured to serve as a trust entity, the token-based asset management engine 122 may configure the components 154, 156, and 158 as not being part of the trust engine 152 but rather as stand-alone components. The transaction engine 153 may cooperate with the components 154, 156, and 158 to facilitate purchasing, holding, and divesting of a portfolio of assets in association with the entity accounts maintained for the users with the third-party electronic exchanges 134 and 136 and accordingly record an investment and/or divestment of the assets in the blockchain ledger 107.

In some embodiments, the transaction engine 153 may receive information including an amount of an asset to acquire or divest from the fractionalizer 154 and processes an exchange to acquire or divest the asset accordingly. The transaction engine 153 may be configured to facilitate a transfer of funds in base currency between a linked fiat currency account of the user and an entity account for the corresponding asset in the electronic exchanges 134 and 136 and initiate purchases to acquire the amount of the asset and/or sales to divest the amount of the assets associated with the entity account. For example, the transaction engine 153 may send a request including instructions to purchase or sell the amount of the asset associated with the entity account on the electronic exchanges 134 and 136. The request sent to the electronic exchanges 134 and 136 may include an account identifier of the user, an asset identifier, and the amount of the asset to acquire or divest.

In a more detailed example of executing an investment, the transaction engine 153 may facilitate a transfer of the base currency corresponding to the investable amount from the linked fiat currency account of the user to an entity account corresponding to an asset. The transaction engine 153 may send a request to the electronic exchange to exchange the base currency corresponding to the investable amount for the amount of the asset. The electronic exchange may execute the investment request accordingly and send a response to the transaction engine 153 indicating that the amount of the asset was successfully acquired into the entity account. The transaction engine 153 may signal the pool manager 156 to generate a number of cryptographically signed asset tokens corresponding to a purchased amount of the asset. The transaction engine 153 may signal the token allocator 158 to record an allocation of the corresponding number of cryptographically signed asset tokens to an account of the user in the blockchain ledger 107 to reflect the investment of the asset.

In a more detailed example of executing a divestment, the transaction engine 153 may send a request to the electronic exchange to exchange the amount of the asset from the entity account into a corresponding amount of the base currency. The electronic exchange may execute the divestment request accordingly and send a response to the transaction engine 153 indicating that the amount of the asset was successfully divested from the entity account. The transaction engine 153 may facilitate a transfer of the corresponding amount of exchanged base currency from the entity account to the linked fiat currency account of the user. The transaction engine 153 may signal the token allocator 158 to record a reallocation or deallocation of the corresponding number of cryptographically signed asset tokens from an account of the user in the blockchain ledger 107 to reflect the divestment of the asset.

In some embodiments, the transaction engine 153 determines whether the amount of the asset to acquire or divest includes at least a fractional share of the asset. In response to determining that there is a fractional share, the transaction engine 153 sends a request to the trust engine 138 of an electronic exchange (e.g., fractional exchange 136). The trust engine 138 of the fractional exchange 136 uses API(s) 153 to process the requests from the token-based asset management engine 122. For example, the fractional exchange 136 serves as a third-party trust entity that can hold whole shares of an indivisible asset, such as stock and allocate fractional shares to individual users in the entity accounts. The request sent to the trust engine 138 may include an account identifier of the user, an asset identifier, and the amount of the asset including the fractional share to acquire or divest.

In some embodiments, the transaction engine 153 allows the user 106 to set up a subaccount within the account to direct investable amount into the subaccount for saving funds toward a purchase of a particular item. For example, the item may be a large item, such as a car, down payment on a house, college tuition, etc. In another example, the item may be a medium-sized purchase, such as a TV, insurance payment, vacation, etc. In another example, the item may be a small purchase, such as a dinner outing, etc. The transaction engine 153 allows the user 106 to direct at least a portion of the investable amount into the subaccount on a regular basis. The transaction engine 153 facilitates an explicit transfer of funds not already held from the linked fiat currency account into the subaccount. The transaction engine 153 invests the funds allocated to the subaccount according to the asset investment mix determined for the account of the user (as reflected by the diversification settings 171 associated with the user's account data 170, which stores data defining the sub-account(s)).

FIGS. 10A-10B show example graphical representations illustrating user interfaces renderable by the asset management application 110 for setting up a subaccount for saving funds toward a purchase and using the invested funds to make a purchase. In FIG. 10A, the user interface 1000 depicts a first page associated with a subaccount set up by the user to save up funds for purchasing a vacation package. The user interface 1000 includes a field 1002 to input an expected cost of the purchase of a vacation package. The user interface 1000 includes an area 1008 to transfer unallocated funds to be saved for the purchase. For example, the user may select the button Deposit 1010 to transfer unallocated funds from the linked fiat currency account of the user to the subaccount. The deposited funds may be invested in a plurality of assets according to the asset investment mix. The user interface 1000 shows the user the appreciation gained from the invested assets in the field 1006 as “Extra Cash.” For example, as the invested assets change in value, the change is shown to the user as a separate amount which may be labeled as “Extra Cash.” This shows the user that it is money earned by the investment and not money from deposits made from the linked fiat currency account. The user interface 1000 also shows to the user a remaining amount 1004 left to save up for the purchase of the vacation package in the field 1002. The asset management application 110, in cooperation with the transaction engine 153, allows the user to transfer some or all of the Extra Cash towards the purchase. The asset management application 110 may present a user notification indicating that the purchase may be made when sufficient amount of the expected cost of the purchase has been saved up (e.g., responsive to receiving corresponding information from the transaction engine 153).

In some embodiments, the transaction engine 153 facilitates the automatic purchase of an item when the total cost of the item has been saved in its subaccount. In FIG. 10B, the user interface 1030 depicts a second page for tracking activity of a user including purchases made using the invested funds. The user interface 1030 shows a purchase transaction 1032 completed by the user. When the user makes payment for a purchase transaction, the asset management application 110 presents a user notification (e.g., generated by the transaction engine 153) indicating how much of the purchase was made with appreciation gained from the invested assets as a “Saved” amount 1034. For example, the second page in the user interface 1030 shows that $15.24 out of total cost $22.62 of the transaction was saved in the purchase transaction 1032 using the appreciation gained from the invested funds.

The blockchain interfaces 155 may include software and/or logic to provide functionality for enabling access to the blockchain network 132 distributing the blockchain ledger 107. In some embodiments, the asset management server 101 may be a node in the blockchain network 132 that hosts a copy of the blockchain ledger 107 in the data storage 243. The other components 152 and 153 (or alternatively, components 154, 156, 158, and 153) of the token-based asset management engine 122 may access the blockchain network 132 distributing the blockchain ledger 107 via the blockchain interfaces 155. The blockchain interfaces 155 may allow the token-based asset management engine 122 to send queries to the blockchain network 132 and receive responses from the blockchain network 132. The blockchain network 132 may be supported by a third-party certifier 173 that signs and secures the blockchain ledger 107. The third-party certifier 173 may ensure that any mutation logged in the blockchain ledger 107 is immutable. For example, the blockchain ledger 107 may enable tracing of a cryptographically signed asset token all the way back to its initial issuance at the time of purchase. The third-party certifier 173 may also issue a certificate to the asset management server 101 used to authenticate its identity. The asset management server 101 and its associated components may use the certificate to identify themselves to the blockchain network 132 for accessing the blockchain ledger 107.

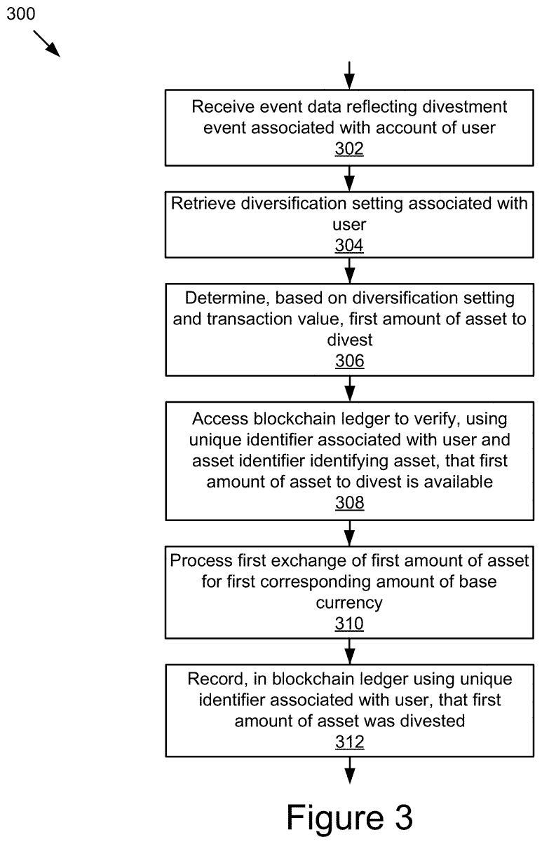

FIG. 3 is a flow diagram illustrating one embodiment of an example method 300 for divesting an asset in accordance with a divestment event. At 302, the transaction engine 153 receives event data reflecting a divestment event associated with an account of a user. For example, the divestment event includes payment made for a transaction and its transaction value in a base currency. At 304, the fractionalizer 154 retrieves a diversification setting associated with the user. For example, the diversification setting may include an asset investment mix, estimated income, estimated expenses, and the investment rate associated with the account of the user. At 306, the fractionalizer 154 determines a first amount of an asset to divest based on the diversification setting and the transaction value. For example, the fractionalizer 154 may select a highest performing asset from a portfolio of assets invested according to the asset investment mix. At 308, the pool manager 156 accesses a blockchain ledger to verify that the first amount of asset to divest is available using a unique identifier associated with the user and an asset identifier identifying the asset. For example, the blockchain ledger may store a set of cryptographically signed asset tokens corresponding to the identified asset in association with the account of the user. At 310, the pool manager 156 processes a first exchange of the first amount of asset for first corresponding amount of base currency. At 312, the token allocator 158 records in the blockchain ledger that the first amount of asset was divested using the unique identifier associated with the user.

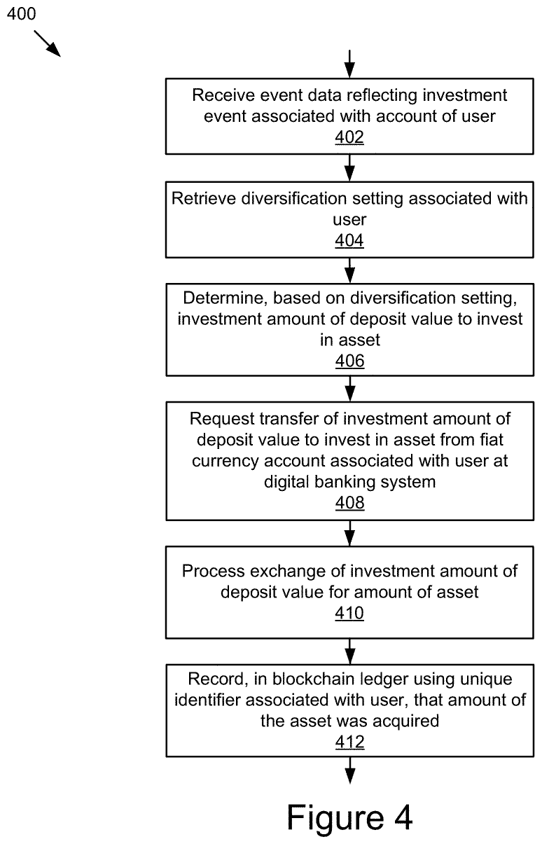

FIG. 4 is a flow diagram illustrating one embodiment of an example method 400 for investing in an asset in accordance with an investment event. At 402, the transaction engine 153 receives event data reflecting an investment event associated with an account 170 of a user. For example, the investment event may include a detection of an electronic deposit of funds, such as a paycheck in base currency in a linked fiat currency account (e.g., personal checking account) of the user. At 404, the fractionalizer 154 retrieves diversification setting associated with the user. At 406, the fractionalizer 154 determines an investment amount of deposit value to invest in an asset based on the diversification setting. For example, the investment amount of deposit value may be determined after deducting from the paycheck estimated expenses of the user included in the diversification setting. At 408, the transaction engine 153 requests a transfer of the investment amount of deposit value from a fiat currency account associated with the user at a digital banking system to invest in the asset. For example, the fiat currency account may be linked to the account 170 of the user. At 410, the pool manager 156 processes an exchange of the investment amount of deposit value for an amount of the asset. At 412, the token allocator 158 records that the amount of the asset was acquired in a blockchain ledger using a unique identifier associated with the user.

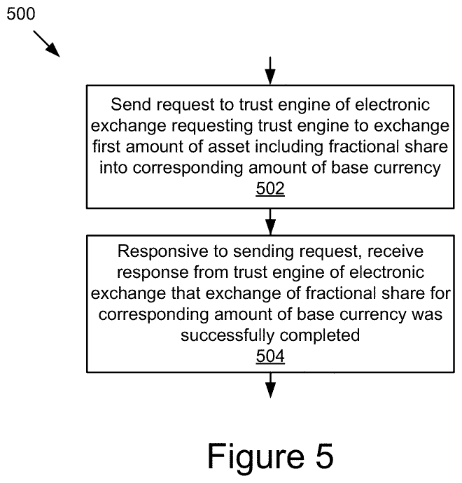

FIG. 5 is a flow diagram illustrating one embodiment of an example method 500 for exchanging a fractional share of an asset of a user. At 502, the transaction engine 153 sends a request to a trust engine of an electronic exchange requesting the trust engine to exchange a first amount of asset including a fractional share into corresponding amount of base currency. At 504, the transaction engine 153 receives a response from the trust engine of the electronic exchange that the exchange of fractional share for the corresponding amount of base currency was successfully completed responsive to sending the request.

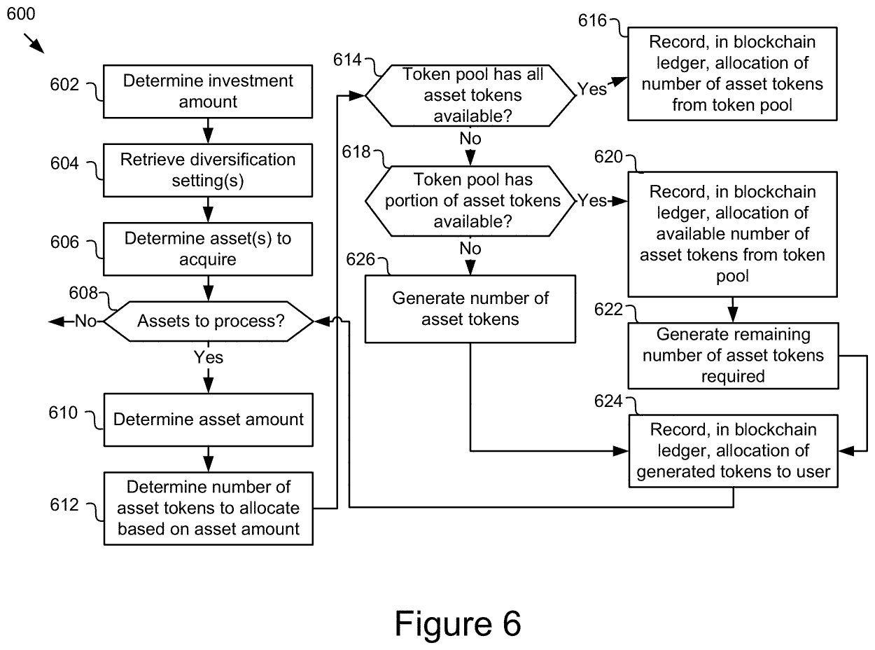

FIG. 6 is a flow diagram illustrating one embodiment of an example method 600 for recording asset investment in a blockchain ledger. At 602, the transaction engine 153 determines an investment amount. For example, the investment amount may be associated with an investment event and may be determined after deduction of fixed expenses from the deposited funds in the fiat currency account of the user. At 604, the fractionalizer 154 retrieves diversification settings associated with a user. For example, the diversification setting may include an asset investment mix for the portfolio of assets associated with the user. At 606, the fractionalizer 154 determines one or more assets to acquire. At 608, the transaction engine 153 verifies whether there are assets determined to be processed. If yes, the method 600 proceeds to 610. At 610, the fractionalizer 154 determines an amount of the asset to acquire. For example, the fractionalizer 154 may determine an asset and an amount of the asset to acquire based on the asset investment mix. At 612, the pool manager 156 determines a number of cryptographically signed asset tokens to allocate based on the amount of the asset. For example, the pool manager 156 may multiply the amount of the asset by 1,000,000 to determine a corresponding number of cryptographically signed asset tokens.

At 614, the pool manager 156 determines whether an unallocated token pool has all the number of cryptographically signed asset tokens available. If the unallocated token pool is determined to have all the number of cryptographically signed asset tokens, at 616, the token allocator 158 records an allocation of the number of cryptographically signed asset tokens from the unallocated token pool in the blockchain ledger. If the unallocated token pool is determined to not have all the number of cryptographically signed asset tokens, at 618, the pool manager 156 determines whether the unallocated token pool has a portion of the number of cryptographically signed asset tokens available. If there is a portion of the number of cryptographically signed asset tokens available, then at 620, the token allocator 158 records the allocation of the available portion of the number of cryptographically signed asset tokens from the unallocated token pool in the blockchain ledger. At 622, the pool manager 156 generates a remaining number of cryptographically signed asset tokens required for allocation. At 624, the token allocator 158 records the allocation of the generated cryptographically signed tokens to the user in the blockchain and method 600 loops back to 608. If even a portion of the number of cryptographically signed asset tokens is unavailable, at 626, the pool manager 156 generates the corresponding number of cryptographically signed asset tokens for the amount of asset and the method 600 proceeds to 624.

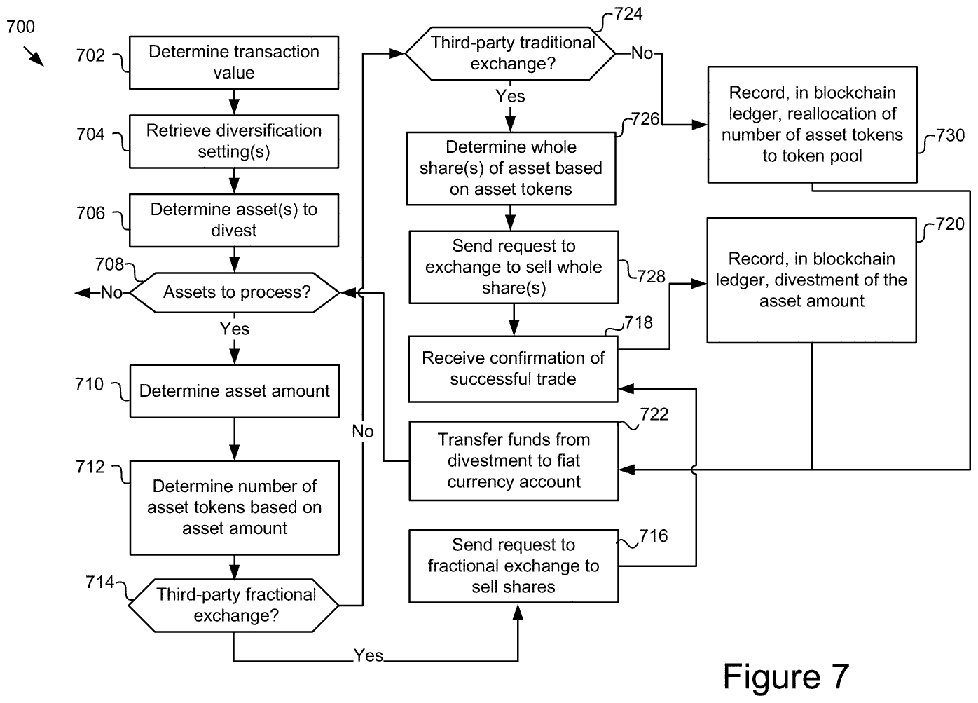

FIG. 7 is a flow diagram illustrating one embodiment of an example method 700 for recording asset divestment in a blockchain ledger. At 702, the transaction engine 153 determines a transaction value. For example, the transaction value is a debit amount for payment in base currency. At 704, the fractionalizer 154 retrieves the diversification settings associated with a user. At 706, the fractionalizer 154 determines one or more assets to divest. At 708, the transaction engine 153 checks whether there are assets determined to be processed. If yes, the method 700 proceeds to 710. At 710, the fractionalizer 154 determines an amount of the asset to divest. At 712, the pool manager 156 determines a number of cryptographically signed asset tokens based on the amount of the asset.

At 714, transaction engine 153 checks whether a third-party fractional exchange is handling the asset targeted for divestment. If so, at 716, the transaction engine 153 sends a request to the fractional exchange to sell shares corresponding to the amount of asset. At 718, the transaction engine 153 receives a confirmation of a successful trade. At 720, the token allocator 158 records a divestment of the amount of the asset in a blockchain ledger. At 722, the transaction engine 153 transfers funds from the divestment of the amount of the asset to a fiat currency account of the user and the method 700 loops back to 708. If the third-party fractional exchange is not handling the asset targeted for divestment, at 724, the transaction engine 153 checks whether a third-party traditional exchange is handling the asset. For example, the traditional exchange may be an electronic exchange that does not support fractional share investing.

If the third-party traditional exchange is handling the asset, at 726, the fractionalizer 154 or the transaction engine 153 determines one or more whole shares of the asset based on the number of cryptographically signed asset tokens. At 728, the transaction engine 153 sends a request to the third-party traditional exchange to sell the one or more whole shares of the asset and the method 700 proceeds through 718, 720, and 722 before looping back to 708. If the third-party traditional exchange is not handling the asset, at 730, the token allocator 158 records reallocation of the number of cryptographically signed asset tokens to the unallocated token pool and the method 700 proceeds to 722 before looping back to 708. For example, the asset management server 101 serving as a trust entity purchases the number of cryptographically signed asset tokens corresponding to the amount of asset and deposits the exchanged funds in base currency in the fiat currency account of the user.

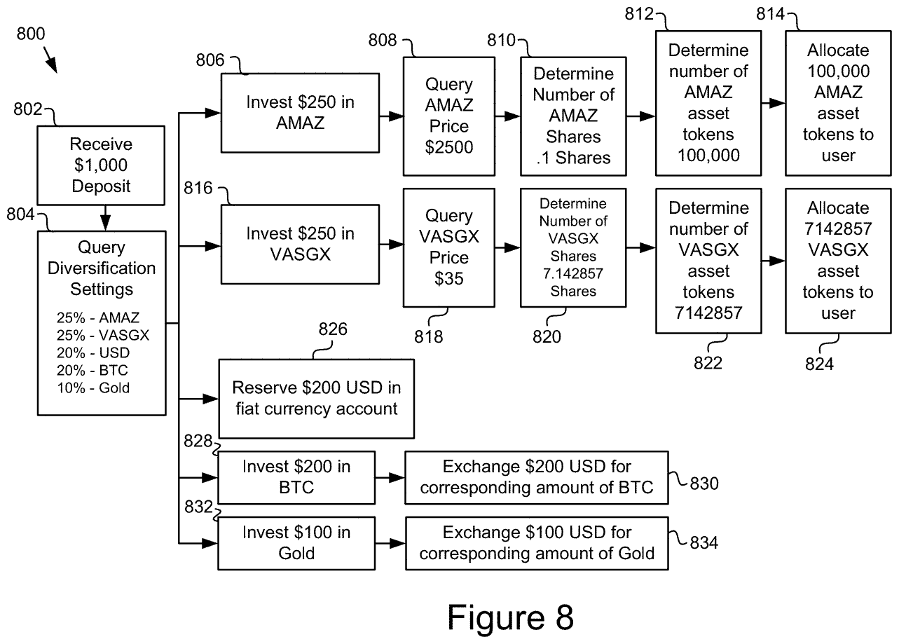

FIG. 8 is a schematic flow diagram illustrating one embodiment of an example method 800 for executing an investment in a portfolio of assets according to an asset investment mix. As indicated in block 802, the transaction engine 153 receives a deposit of $1000 in a linked fiat currency account of a user. In block 804, the fractionalizer 154 queries diversification settings associated with the user. For example, the diversification settings include an asset investment mix. As indicated in block 804, an asset investment mix provides a percentage allocation of 25% to AMAZ stock, 25% to VASGX mutual fund, 20% to USD, 20% to BTC cryptocurrency and 10% to gold.

In the depicted example, the fractionalizer 154 splits the $1000 deposit into individual amounts for investing in each asset according to the asset investment mix. For example, the fractionalizer 154 determines $250 as the amount to invest in AMAZ stock (25%), $250 as the amount to invest in VASGX stock (25%), $200 as the amount in USD (20%) to reserve in the fiat currency account, $200 as the amount to invest in BTC cryptocurrency (20%), and $100 as the amount to invest in gold (10%).

In block 806, the fractionalizer 154 determines $250 as the amount out of $1000 deposit to invest in AMAZ stock according to the asset investment mix. To invest $250 in AMAZ stock, the fractionalizer 154 queries a current market price for AMAZ stock and determines that it is $2500 as indicated in block 808. In block 810, the fractionalizer 154 determines a number of AMAZ shares to acquire. For example, the fractionalizer 154 divides the amount to invest ($250) in AMAZ by its current market value ($2500) to determine an amount (e.g., 0.1 share) of the AMAZ to acquire. In block 812, the pool manager 156 determines a number of cryptographically signed asset tokens corresponding to the amount of AMAZ shares. For example, the pool manager 156 multiplies the amount (0.1) of the AMAZ shares by 1,000,000 to determine the number of cryptographically signed asset tokens (100,000). In block 814, the token allocator 158 allocates 100,000 of cryptographically signed asset tokens corresponding to AMAZ to the user in a blockchain ledger.

In block 816, the fractionalizer 154 determines $250 as the amount out of $1000 deposit to invest in VASGX mutual fund according to the asset investment mix. To invest $250 in VASGX mutual fund, the fractionalizer 154 queries a current market price for VASGX mutual fund and determines that it is $35 as indicated in block 818. In block 820, the fractionalizer 154 determines a number of VASGX shares to acquire. For example, the fractionalizer 154 divides the amount to invest ($250) in VASGX by its current market value ($35) to determine an amount (e.g., 7.142857 shares) of the VASGX to acquire. In block 822, the pool manager 156 determines a number of cryptographically signed asset tokens corresponding to the amount of VASGX shares. For example, the pool manager 156 multiplies the amount (7.142857) of the VASGX shares by 1,000,000 to determine the number of cryptographically signed asset tokens (7,142,857). In block 824, the token allocator 158 allocates 7,142,857 of cryptographically signed asset tokens corresponding to VASGX mutual fund to the user in a blockchain ledger. In block 826, the transaction engine 153 reserves $200 in the fiat currency account of the user according to the asset investment mix. In block 828, the fractionalizer 154 determines $200 as the amount out of $1000 deposit to invest in BTC cryptocurrency according to the asset investment mix. In block 830, the transaction engine 153 exchanges $200 USD for corresponding amount of BTC cryptocurrency. In block 832, the fractionalizer 154 determines $100 as the amount out of $1000 deposit to invest in gold according to the asset investment mix. In block 834, the transaction engine 153 exchanges $100 USD for corresponding amount of gold.

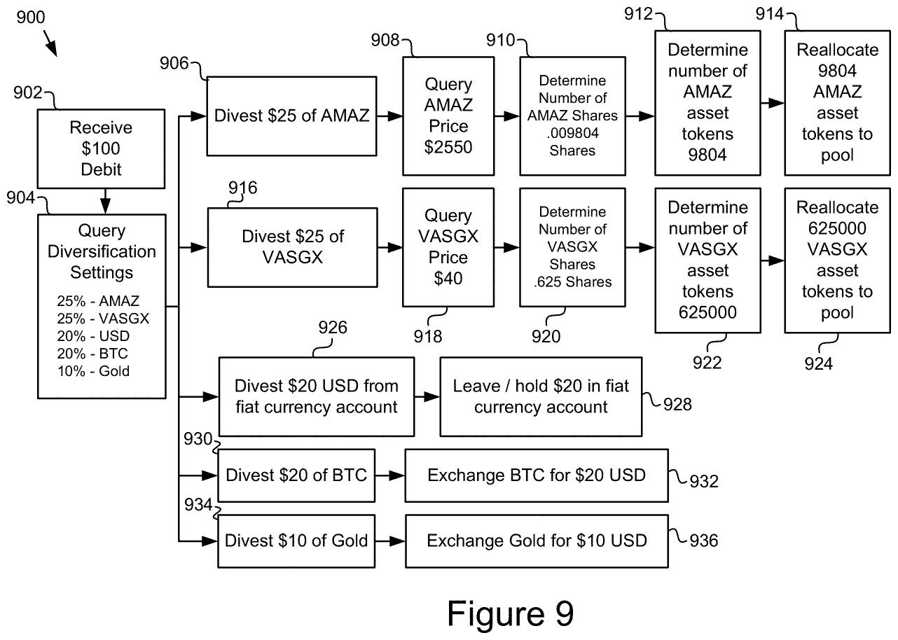

FIG. 9 is a schematic flow diagram 900 illustrating one embodiment of an example method 800 for executing a divestment of a portfolio of assets according to an asset investment mix. As indicated in block 902, the transaction engine 153 receives a debit of $100 from a debit card associated with a linked fiat currency account of a user. In block 904, the fractionalizer 154 queries diversification settings associated with the user. For example, the diversification settings include an asset investment mix. As indicated in block 904, an asset investment mix provides a percentage allocation of 25% to AMAZ stock, 25% to VASGX mutual fund, 20% to USD, 20% to BTC cryptocurrency and 10% to gold.

In block 906, the fractionalizer 154 determines $25 as the amount to divest from AMAZ stock according to the asset investment mix. To divest $25 of AMAZ stock, the fractionalizer 154 queries a current market price for AMAZ stock and determines that it is $2550 as indicated in block 908. In block 910, the fractionalizer 154 determines a number of AMAZ shares to divest. For example, the fractionalizer 154 divides the amount to divest ($25) by the current market value ($2550) of the AMAZ stock to determine an amount (e.g., 0.009804 share) of the AMAZ shares to divest. In block 912, the pool manager 156 determines a number of cryptographically signed asset tokens corresponding to the amount of AMAZ shares. For example, the pool manager 156 multiplies the amount (0.009804) of the AMAZ shares by 1,000,000 to determine the number of cryptographically signed asset tokens (9804). In block 914, the token allocator 158 reallocates 9804 of cryptographically signed asset tokens corresponding to AMAZ to the unallocated token pool.

In block 916, the fractionalizer 154 determines $25 as the amount to divest from VASGX mutual fund according to the asset investment mix. To divest $25 of VASGX mutual fund, the fractionalizer 154 queries a current market price for VASGX mutual fund and determines that it is $40 as indicated in block 918. In block 920, the fractionalizer 154 determines a number of VASGX shares to divest. For example, the fractionalizer 154 divides the amount to divest ($25) in VASGX by its current market value ($40) to determine an amount (e.g., 0.625 shares) of the VASGX to divest. In block 922, the pool manager 156 determines a number of cryptographically signed asset tokens corresponding to the amount of VASGX shares. For example, the pool manager 156 multiplies the amount (0.625) of the VASGX shares by 1,000,000 to determine the number of cryptographically signed asset tokens (625,000). In block 924, the token allocator 158 reallocates 625,000 of cryptographically signed asset tokens corresponding to VASGX mutual fund to the unallocated token pool. In block 926, the transaction engine 153 divests $20 from the fiat currency account of the user according to the asset investment mix. In block 928, the transaction engine 153 leaves or places a hold on $20 in the fiat currency account of the user. In block 930, the fractionalizer 154 determines $20 as the amount to divest from BTC cryptocurrency according to the asset investment mix. In block 932, the transaction engine 153 exchanges a corresponding amount of BTC cryptocurrency for $20 USD. In block 934, the fractionalizer 154 determines $10 as the amount to divest from gold according to the asset investment mix. In block 936, the transaction engine 153 exchanges a corresponding amount of gold for $10 USD.

Technology for managing a portfolio of assets including automated investing and/or divesting of the assets using a blockchain ledger has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

It should be understood that language which refers to a list of items such as “at least one of A, B, or C” (example 1) means “at least one of A, B and/or C.” Likewise, it should be understood that language which refers to a list of items such as “at least one of A, B, and C” (example 2) means “at least one of A, B and/or C.” The list of items in example 2 is not required to include one of each item. The lists of items in both examples 1 and 2 can mean “only one item from the list or any combination of items in the list.” That is, the lists of items (in both examples 1 and 2) can mean only A, or only B, or only C, or any combination of A, B, and C (e.g., AB, AC, BC, or ABC).

It should be further understood that the terms “comprises,” “has,” “includes”, “comprising,” “having,” and/or “including” are open ended and when used in this specification, specify the presence of stated features, integers, steps, operations, elements, and/or components, but do not preclude the presence or addition of one or more other features, integers, steps, operations, elements, components, and/or groups thereof.

Some portions of the detailed descriptions described above are presented in terms of algorithms and symbolic representations of operations on data bits within a computer memory.

These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of a hardware embodiment, a software embodiment, or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Various general-purpose systems may be used with programs in accordance with the teachings herein, or it may prove convenient to construct more specialized apparatus to perform the required method steps. The required structure for a variety of these systems will appear from the description above. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
receiving first event data reflecting a divestment event associated with an account of a user, the divestment event including a transaction value in a base currency;
retrieving, from a database, a diversification setting associated with the user;
determining, based on the diversification setting and the transaction value, a first amount of an asset to divest;
accessing, via a network, a blockchain ledger to verify, using a unique identifier associated with the user and an asset identifier identifying the asset, that the first amount of the asset to divest is available;
processing a first exchange of the first amount of the asset for a first corresponding amount of the base currency; and
recording, in the blockchain ledger using the unique identifier associated with the user, that the first amount of the asset was divested.

2. The computer-implemented method of claim 1, further comprising:
determining that the first amount of the asset is a fractional share, wherein:
processing the first exchange includes sending a request, via the network, to a trust engine of an electronic exchange requesting the trust engine to exchange the first amount of the asset including the fractional share into the first corresponding amount of the base currency, the request including an account identifier of the user, the asset identifier, and the first amount of the asset to divest; and
responsive to sending the request, receiving, via the network, a response from the trust engine of the electronic exchange that the first exchange of the first amount of the asset for the first corresponding amount of the base currency was successfully completed.

3. The computer-implemented method of claim 1, further comprising:
determining a number of cryptographically signed asset tokens to reallocate based on the first amount of the asset; and
recording, in the blockchain ledger, a reallocation of the number of cryptographically signed asset tokens representing the first amount of the asset to a token pool.

4. The computer-implemented method of claim 3, wherein at least one of the cryptographically signed asset tokens includes:
the unique identifier associated with the user;
the asset identifier;
a transaction identifier;
a market value of the asset at a time of the first exchange;
a multiplier value;
a timestamp of the reallocation; and
a cryptographic signature.

5. The computer-implemented method of claim 3, further comprising:
determining that the first amount of the asset is a fractional share, wherein at least a portion of the number of cryptographically signed asset tokens represents the fractional share.

6. The computer-implemented method of claim 1, wherein:
the asset is one of a plurality of assets associated with the user; and
determining the first amount of the asset to divest further comprises:
determining, relative to a time of the divestment event, a percentage gain for each of the plurality of assets; and
selecting the asset from among the plurality of assets to divest based on a corresponding percentage gain.

7. The computer-implemented method of claim 1, further comprising:
receiving second event data reflecting an investment event associated with the account of the user, the investment event including a deposit value in the base currency;
retrieving, from the database, the diversification setting associated with the user;
determining, based on the diversification setting, an investment amount of the deposit value to invest in the asset;
requesting, via the network, a transfer of the investment amount of the deposit value to invest in the asset from a fiat currency account associated with the user at a digital banking system;
processing a second exchange of the investment amount of the deposit value for a second amount of the asset; and
recording, in the blockchain ledger using the unique identifier associated with the user, that the second amount of the asset was acquired.

8. The computer-implemented method of claim 7, wherein processing the second exchange of the investment amount of the deposit value for the second amount of the asset includes:
accessing, via the network, the blockchain ledger to verify a token pool includes a sufficient number of cryptographically signed asset tokens to cover the second exchange; and
responsive to positively verifying that the token pool includes the sufficient number of cryptographically signed asset tokens, recording, in the blockchain ledger using the unique identifier associated with the user, an allocation of a number of cryptographically signed asset tokens that correspond to the investment amount of the deposit value.

9. The computer-implemented method of claim 7, wherein processing the second exchange of the investment amount of the deposit value for the second amount of the asset includes:
accessing, via the network, the blockchain ledger to determining how many cryptographically signed asset tokens are in a token pool;
determining that the token pool includes a portion of the cryptographically signed asset tokens needed to cover the second exchange;
recording, in the blockchain ledger using the unique identifier associated with the user, a first allocation of the portion of the cryptographically signed asset tokens from the token pool to the account of the user;
generating a remaining number of cryptographically signed asset tokens needed to cover the second exchange; and
recording, in the blockchain ledger using the unique identifier associated with the user, a second allocation of the remaining number of the cryptographically signed asset tokens.

10. The computer-implemented method of claim 7, wherein the investment event is an electronic deposit of the base currency in the fiat currency account associated with the user at the digital banking system.

11. The computer-implemented method of claim 1, wherein the divestment event is an electronic preauthorization request for a transaction being processed by a merchant in association with the user.

12. The computer-implemented method of claim 1, wherein the asset comprises a public stock or a precious metal.

13. The computer-implemented method of claim 1, further comprising:
transferring, via the network to a fiat currency account associated with the user at a digital banking system, at least the first corresponding amount of the base currency.

14. A system comprising:
one or more processors; and
a memory, the memory storing instructions, which when executed cause the one or more processors to:
receive first event data reflecting a divestment event associated with an account of a user, the divestment event including a transaction value in a base currency;
retrieve, from a database, a diversification setting associated with the user;
determine, based on the diversification setting and the transaction value, a first amount of an asset to divest;
access, via a network, a blockchain ledger to verify, using a unique identifier associated with the user and an asset identifier identifying the asset, that the first amount of the asset to divest is available;
process a first exchange of the first amount of the asset for a first corresponding amount of the base currency; and
record, in the blockchain ledger using the unique identifier associated with the user, that the first amount of the asset was divested.

15. The system of claim 14, wherein the instructions further cause the one or more processors to:
determine that the first amount of the asset is a fractional share, wherein the instructions to process the first exchange includes:
send a request, via the network, to a trust engine of an electronic exchange requesting the trust engine to exchange the first amount of the asset including the fractional share into the first corresponding amount of the base currency, the request including an account identifier of the user, the asset identifier, and the first amount of the asset to divest; and
responsive to sending the request, receive, via the network, a response from the trust engine of the electronic exchange that the first exchange of the first amount of the asset for the first corresponding amount of the base currency was successfully completed.

16. The system of claim 14, wherein the instructions further cause the one or more processors to:
determine a number of cryptographically signed asset tokens to reallocate based on the first amount of the asset; and
record, in the blockchain ledger, a reallocation of the number of cryptographically signed asset tokens representing the first amount of the asset to a token pool.

17. The system of claim 14, wherein the instructions further cause the one or more processors to:
receive second event data reflecting an investment event associated with the account of the user, the investment event including a deposit value in the base currency;
retrieve, from the database, the diversification setting associated with the user;
determine, based on the diversification setting, an investment amount of the deposit value to invest in the asset;
request, via the network, a transfer of the investment amount of the deposit value to invest in the asset from a fiat currency account associated with the user at a digital banking system;
process a second exchange of the investment amount of the deposit value for a second amount of the asset; and
record, in the blockchain ledger using the unique identifier associated with the user, that the second amount of the asset was acquired.

18. The system of claim 17, wherein to process the second exchange of the investment amount of the deposit value for the second amount of the asset, the instructions further cause the one or more processors to:
access, via the network, the blockchain ledger to verify a token pool includes a sufficient number of cryptographically signed asset tokens to cover the second exchange; and
responsive to positively verifying that the token pool includes the sufficient number of cryptographically signed asset tokens, record, in the blockchain ledger using the unique identifier associated with the user, an allocation of a number of cryptographically signed asset tokens that correspond to the investment amount of the deposit value.

19. The system of claim 17, wherein to process the second exchange of the investment amount of the deposit value for the second amount of the asset, the instructions further cause the one or more processors to:
access, via the network, the blockchain ledger to determining how many cryptographically signed asset tokens are in a token pool;
determine that the token pool includes a portion of the cryptographically signed asset tokens needed to cover the second exchange;
record, in the blockchain ledger using the unique identifier associated with the user, a first allocation of the portion of the cryptographically signed asset tokens from the token pool to the account of the user;
generate a remaining number of cryptographically signed asset tokens needed to cover the second exchange; and
record, in the blockchain ledger using the unique identifier associated with the user, a second allocation of the remaining number of the cryptographically signed asset tokens.

20. A system comprising:
means for receiving first event data reflecting a divestment event associated with an account of a user, the divestment event including a transaction value in a base currency;
means for retrieving a diversification setting associated with the user;
means for determining, based on the diversification setting and the transaction value, a first amount of an asset to divest;
means for accessing, via a network, a blockchain ledger to verify, using a unique identifier associated with the user and an asset identifier identifying the asset, that the first amount of the asset to divest is available;
means for processing a first exchange of the first amount of the asset for a first corresponding amount of the base currency; and
means for recording, in the blockchain ledger using the unique identifier associated with the user, that the first amount of the asset was divested.
